(19) United States
(12) Patent Application Publication
(10) Pub. No.: US 2025/0360899 A1
(43) Pub. Date: Nov. 27, 2025

(54) PEDAL TRAVEL SIMULATOR FOR A MOTOR VEHICLE BRAKE, AND HYDRAULIC BLOCK

(71) Applicants: ZF Active Safety GmbH, Koblenz (DE); ZF Automotive Technologies (Shanghai) Co., Ltd, Shanghai (CN)

(72) Inventors: Michael Geider, Urmitz (DE); Jiuliang Jiang, Shanghai (CN); Martin Struschka, Braubach (DE); Soeren Lehmler, Kobern-Gondorf (DE); David Lopez Larequi, Koblenz (DE)

(21) Appl. No.: 19/214,186

(22) Filed: May 21, 2025

(30) Foreign Application Priority Data
May 22, 2024 (DE) 102024114292.8

(51) Int. Cl. B60T 8/40; B60T 17/08

(52) U.S. Cl. CPC B60T 8/409; B60T 17/08

(57) ABSTRACT

The invention relates to a pedal travel simulator (100) for a motor vehicle brake, having a movably arranged simulator piston (1), an elastic element (2) that makes direct contact with the simulator piston, and a damping element (4). In a first portion (23a, 23b) of a simulator force-travel curve (200), a simulator piston force is provided by the elastic element (2). In a second portion (24a, 24b) of the simulator force-travel curve (200), the simulator piston force is provided by the elastic element (2) and the damping element (4) in parallel.

The invention also relates to a hydraulic block (300) comprising a pedal travel simulator (100).

### TECHNICAL FIELD

The invention relates to a pedal travel simulator for a motor vehicle brake, in particular for a motor vehicle, such as a passenger motor vehicle, having a hydraulic brake control unit. The invention also relates to a hydraulic block comprising a pedal travel simulator, preferably a hydraulic block of an electrohydraulic brake control unit.

### BACKGROUND

In power-operated hydraulic motor vehicle brakes, a pressure generator is used to generate a fluid pressure, which is conducted to the wheel brakes. For the control of the pressure generator, a brake pedal position is read off at a master brake cylinder, and the pressure generator is controlled in a manner dependent on said brake pedal position. In such motor vehicle brakes, during normal operation, there is no hydraulic connection between the master brake cylinder and the wheel brakes. Only the pressure generator applies a fluid pressure to the wheel brakes, in a manner dependent on the brake pedal.

In order that a vehicle driver is provided with haptic feedback at the brake pedal during a power braking operation, a pedal travel simulator is provided in the brake system. If the motor vehicle driver actuates the brake pedal, the fluid situated in the master brake cylinder is displaced into the pedal travel simulator and generates an opposing pressure there. This opposing pressure reacts on the piston in the master brake cylinder and pushes the brake pedal back into its original position. A pedal pressure perceived by the motor vehicle driver as pleasant is thus generated at the motor vehicle driver's foot.

If the pressure generator fails, or if some other fault occurs, it may be the case that the motor vehicle driver can apply brake fluid to the wheel brakes using the brake pedal, and that this is not performed by means of the pressure generator. In such a situation, the pedal travel simulator is hydraulically separated from the master brake cylinder, and therefore does not receive any fluid. It is thus possible to achieve a fast response of the wheel brakes to the input made by the vehicle driver.

Various pedal travel simulators are known from the prior art.

For example, DE 10 2020 204 352 A1 discloses a pedal travel simulator having a spring ring. The pedal travel simulator comprises a spring ring that serves as a stop for the simulator piston. Said spring ring is positioned in encircling groove in a cylinder between the piston and the end face of a cylinder. The spring ring thus protrudes inwardly out of the groove, so as to limit a stroke of the simulator piston in the direction of a cover.

DE 11 2019 004 640 T5 has disclosed a pedal simulator that is intended to provide an improved pedal feel.

It is desirable to generate different force-travel curves for the pedal travel simulator for different vehicles and in particular different vehicle classes, because it is the intention for every motor vehicle to have a different brake pedal characteristic. It has proven to be disadvantageous that known pedal travel simulators are of complex construction and are complex to manufacture, and moving parts result in increased noise emissions. This is a problem in particular in vehicles that are operated partly without an internal combustion engine, such that noises of other assemblies stand out. There is also a demand to maximize the useful space in the vehicle.

### SUMMARY

It is therefore an object of the present invention to overcome the disadvantages of the prior art and in particular to specify a pedal travel simulator which allows straightforward adjustment of the force-travel curve and operates with reduced noise. It is also sought to simplify the assembly of the pedal travel simulator, and to arrange the pedal travel simulator in a hydraulic block in a manner that is optimized in terms of structural space.

Said object is achieved by means of a pedal travel simulator for an at least partially hydraulically operating brake system of a motor vehicle brake, the pedal travel simulator having a simulator piston, which is received in a simulator cylinder bore so as to be movable along a central longitudinal axis, and an elastic element, which makes direct contact with the simulator piston. The pedal travel simulator furthermore comprises a damping element, wherein, in a first portion of a simulator force-travel curve, a simulator piston force is provided by the elastic element. According to the invention, in a second portion of the simulator force-travel curve, the simulator piston force is provided by the elastic element and the damping element in parallel.

The brake fluid that is pressurized by the brake pedal is conducted to the simulator piston, which is mounted in a simulator cylinder bore. Provision is made for the elastic element to be in direct contact with the simulator piston, that is to say no additional component is required to transmit the force from the simulator piston to the elastic element. A potential source of noise emissions is thus eliminated owing to the fact that direct contact is made with the elastic element. Furthermore, the elastic element may be connected to the simulator piston via a thrust disc, said disc being used to absorb vibrations and therefore preferably being manufactured from a damping material or having such a coating.

The elastic element is preferably sleeve-shaped and may comprise a helical spring. Preferably, the elastic element is wound around the central longitudinal axis and consists of a material of high elasticity and/or with good energy storage capability. In the rest position, the elastic element is situated for the most part in the simulator piston.

A simulator piston force can be understood as a force which is applied by the pedal travel simulator to the simulator piston, and which pushes against the hydraulic fluid flowing in from the brake pedal. In a first portion of a simulator force-travel curve, a simulator piston force is provided by the elastic element. A simulator piston force can be understood as a simulator force. Both terms refer to a force that is applied to the master brake cylinder by the hydraulic fluid from the pedal travel simulator.

A simulator force-travel curve depicts the simulator piston force applied by the pedal travel simulator, plotted versus the simulator piston travel. A first portion can be described over a first simulator piston travel in which only the elastic element operates. The first portion of the force-travel curve may be shorter or longer depending on the intended use of the pedal travel simulator. In any case, the first portion starts at a simulator piston travel of 0, that is to say the rest position, and ends at the transition to the second portion of the force-travel curve.

In order that only the elastic element absorbs the simulator piston travel in a first portion of the force-travel curve, the elastic element may be supported, preferably on a housing or on some other component of the simulator piston unit. The elastic element is not supported on the damping element. The gradient of the force-travel curve in the first portion can furthermore be influenced by way of different materials used to produce the elastic element.

In a second portion of the force-travel curve, the simulator piston force is provided by the elastic element and the damping element in parallel. The second portion may directly adjoin the first portion of the force-travel curve, or there may be an idle travel between the first and the second portion. The second portion of the force-travel curve is characterized by the fact that the simulator piston force no longer increases linearly, but increases exponentially over the simulator piston travel. In the second portion, the damping element and the elastic element operate jointly and act in parallel on the simulator piston.

Furthermore, the first and second portions of the force-travel curve may be adjoined by a further portion in which only the damping element is deformed and the elastic element is deformed no further. Accordingly, in a third portion, the simulator piston force is provided by the damping element alone. Preferably, in addition to the damping element, a further element may be used for damping the simulator piston force in order to provide a further exponentially increasing profile of the simulator force versus the simulator piston travel.

In a preferred embodiment, the elastic element is arranged along the central longitudinal axis and has two axial ends, wherein the elastic element is supported in particular at the axial ends. The elastic element is preferably sleeve-shaped and may take the form of a spiral spring having two axial ends. In a further embodiment, the elastic element is designed as a spring washer or as a stacked spring washer pair. A plurality of these spring washer pairs can subsequently be stacked one on top of the other and thus achieve a spring action.

The elastic element is supported by way of the two axial ends, whereby neither vibrations nor the simulator piston force cause the elastic element to make contact with other components, and this leads to a further noise reduction. The fastening of the elastic element at only two locations furthermore minimizes additional noise sources, at the contact surfaces of which noise emissions could be generated.

According to a further aspect, the elastic element is installed under axial preload. During installation, the elastic element is placed under stress and installed, with a preload being maintained after the installation process. The characteristic of the force-travel curve can be set by way of the preload, and it is thus possible, using the same springs, to implement different characteristics by way of different preloads. Additionally, the preloaded spring has the effect that said spring is prevented from sagging and making contact with other components. Depending on the spring preload, it is possible for the installation space to be made compact, because the spring exhibits little sagging under high preload.

In one embodiment, the elastic element has a linear force-travel characteristic. It has been found that a response behaviour of the force-travel curve in the first portion is particularly advantageous if it has a linear characteristic. Since the first portion of the force-travel curve is provided only by the elastic element, it is expedient for said elastic element to have a linear characteristic and preferably high mechanical efficiency. It is advantageous that the elastic element has only a relatively low damping action, and largely releases the stored spring energy again.

It is however also possible for the elastic element to have a non-linear force-travel characteristic, and to have a characteristic of a disc spring, for example. The disc spring has a characteristic in which the spring force increases exponentially with increasing deflection.

In a further advantageous refinement, the pedal travel simulator comprises a simulator cap by which the pedal travel simulator is shielded with respect to the surroundings, wherein the damping element is arranged entirely in the simulator cap. In order that a force can be imparted to the simulator piston, the elastic element and the damping element must be supported. Said support may be provided for example by means of the simulator cap. The simulator cap additionally serves to seal off the components within the pedal travel simulator with respect to the surroundings. For this purpose, the simulator cap may be produced from a preferably deep-drawn metal and have a continuous surface in order that no dirt enters the pedal travel simulator.

The simulator cap is preferably formed as a planar element having an internal volume, with the damping element being arranged entirely in said internal volume. To fix the damping element in the simulator cap, the latter may have a device, or the clamping element is adhesively bonded into the simulator cap.

In a further embodiment, one end of the elastic element is supported fixedly relative to the damping element. In order that only the elastic element generates the simulator piston force in the first portion of the force-travel curve, it is necessary that no force is exerted on the damping element by the simulator piston or exerted on the damping element by the elastic element. Therefore, the opposing force of the simulator spring is supported on the housing of the pedal travel simulator, and to this end the simulator cap can be utilized for support. There is thus mechanical decoupling between the elastic element and the damping element in the first portion of the force-travel curve. As soon as the second portion of the force-travel curve has begun, a connection is established between the simulator piston and the damping element.

According to a further aspect of the invention, the elastic element is supported by way of a first end on the simulator piston and the elastic element is supported by way of a second end on the simulator cap. Owing to the preload of the elastic element, said elastic element is clamped between the simulator piston and simulator cap and, via the two axial ends, fixes the components relative to one another. This arrangement between simulator cap, simulator piston and elastic element gives rise to a pedal travel simulator assembly that is easy to handle. This assembly can subsequently be inserted without additional parts into a hydraulic block. This allows inexpensive preassembly and easier material handling and material stocking.

To support the elastic element on the simulator cap, a further component may be provided, which establishes a connection between these two components without contact being made with the damping element.

In a preferred embodiment, the damping element has a larger hysteresis loop than the elastic element. Owing to the larger hysteresis loop, the damping element generates greater (internal) friction, whereby the mechanical work is converted into heat and a damping action is thus generated. By contrast, the elastic element has a relatively small hysteresis loop, that is to say it exhibits greater efficiency than the damping element, and thus has a lesser damping characteristic. A hysteresis loop could be understood as the damping characteristic of the elastic element and of the damping element, wherein, at any rate, the damping characteristic of the damping element is greater, and preferably significantly greater, than that of the elastic element.

In a further embodiment, the elastic element and the damping element are arranged in a working space, wherein the working space extends at least partially in the simulator cap, and the working space is filled with a gas. A working space is to be understood as the volume which is situated within the pedal travel simulator and in which the elastic element and the damping element move. This space is preferably spanned by the simulator cap and the hollow simulator piston.

This working space is filled with a gas and is therefore free from a brake fluid, for which reason the working space must be fluid-tightly sealed with respect to the surroundings. In the first and second portions of the force-travel curve, the gas situated in the working space is compressed and generates an additional force component, which acts on the simulator piston. The pedal travel characteristic can be further optimized by way of a preset initial pressure within the working space during the production process. The gas is preferably (breathable) air or a non-reactive gas or gas mixture (inert gas).

The pedal travel simulator may have a valve device that allows the gas situated in the working space to be selectively connected to or separated from the surroundings. In this way, during a compression process, the gas in the working space can be released, or the working space can be positively pressurized in order to adapt the pedal travel simulator to the presently desired pedal travel characteristic.

According to a further aspect of the invention, the simulator cap has a receiving bore in which the simulator piston is received whilst in the second portion. Whilst in the first portion, the simulator piston moves in a bore formed in a hydraulic block. When the second portion of the force-travel curve is reached, the simulator piston has been pushed in the direction of the simulator cap to such an extent as to move partially within the simulator cap. For the guidance of the simulator piston in the simulator cap, a receiving bore may be provided, by means of which the simulator piston is guided. Formed at the end of the receiving bore is an axial stop against which the simulator piston presses when the simulator piston has covered the entire movement travel. Said stop prevents destruction of the pedal travel simulator, of the elastic element and of the damping element.

A force-transmitting element is rigidly coupled to the simulator piston, wherein the force-transmitting element presses against the damping element after the first portion of the simulator force-travel curve has been passed through. In order that, in the second portion of the force-travel curve, both the elastic element and the damping element can operate in parallel, the simulator piston force must be transmitted from the damping element to the simulator piston directly, not via the elastic element. A force-transmitting element is provided for this purpose.

The parallel configuration commences as soon as the force-transmitting element presses against the damping element. The force flow branches from the simulator piston to the elastic element and the damping element. The force-transmitting element may extend along the central longitudinal axis and move within the sleeve-shaped elastic element.

The object is furthermore achieved by means of a hydraulic block comprising a pedal travel simulator, wherein the hydraulic block has a plurality of bores for receiving electromagnetic valves. The pedal travel simulator constitutes a subassembly of the hydraulic block and may be produced in a preceding step and then installed as a subassembly into the hydraulic block. Further components such as electromagnetic valves or the master brake cylinder are arranged in the hydraulic block. The hydraulic block has fluid outlets for individual wheel brakes and may have a device for generating pressure or perform tasks such as anti-lock braking, electronic stability control or a steer-by-wire braking function.

In a preferred embodiment, the force-transmitting element is movable within the hydraulic block in the first portion of the simulator force-travel curve and is movable at least partially out of the hydraulic block in the second portion of the simulator force-travel curve. The simulator cap normally protrudes outside of a delimiting surface of the hydraulic block. When the simulator piston moves within the pedal travel simulator, the force-transmitting element rigidly connected to the simulator piston moves with it and protrudes, within the simulator cap, beyond the delimiting surface of the hydraulic block.

According to a second aspect of the invention, the hydraulic block has a master brake cylinder bore for a master brake cylinder, wherein the simulator bore is orthogonal to the master brake cylinder bore. This arrangement has been proven as a concept and makes it possible to achieve a short fluidic connection between the simulator bore and master brake cylinder bore. Advantageous positioning of the simulator cap in relation to the hydraulic block is also achieved, making it easier to arrange the hydraulic block in the motor vehicle.

In a preferred embodiment, a fluid port of the pedal travel simulator is arranged in a brake circuit. For this purpose, the pedal travel simulator is directly connected to a shut-off valve that is electromechanically switchable between a pass-through position and a shut-off position.

Proceeding from a fluid chamber in the master brake cylinder, the pressurized fluid flows to a first brake circuit. The fluid is split up in this brake circuit and can flow both to the shut-off valve of the pedal travel simulator and to the wheel brakes. The fluid path to the wheel brakes can be shut off by means of at least one further electromagnetically actuatable valve. In particular, a 3/2 directional valve is provided for this purpose.

In a brake-by-wire operating mode, the fluid circuit to the wheel brakes is interrupted, and the shut-off valve of the pedal travel simulator is opened. A fluid pressure from the master brake cylinder is thus conducted into the pedal travel simulator in order to generate a brake feel at the brake pedal for the motor vehicle driver. The deceleration of the motor vehicle is ensured by means of the pressure generator. If a pressure generator fails and braking in accordance with a brake-by-wire principle is therefore not available, a manual override (push through) is possible. For this purpose, the shut-off valve of the pedal travel simulator is switched into the closed position, and a valve of the brake circuit is opened, such that the fluid from the master brake cylinder passes to the wheel brakes.

### BRIEF DESCRIPTION OF THE DRAWINGS

Further features, advantages and properties of the invention will be discussed in the description of preferred embodiments of the invention with reference to the figures, in which:

FIG. 1: shows an embodiment of a pedal travel simulator according to the invention in a sectional illustration,

FIG. 2: shows the qualitative profile of a simulator force-travel curve of a pedal travel simulator according to the invention,

FIG. 3: shows an embodiment of a hydraulic block according to the invention in a sectional illustration, having a pedal travel simulator according to FIG. 1, and

FIGS. 4a-4c: show different embodiments of the damping element in a perspective view.

### DESCRIPTION

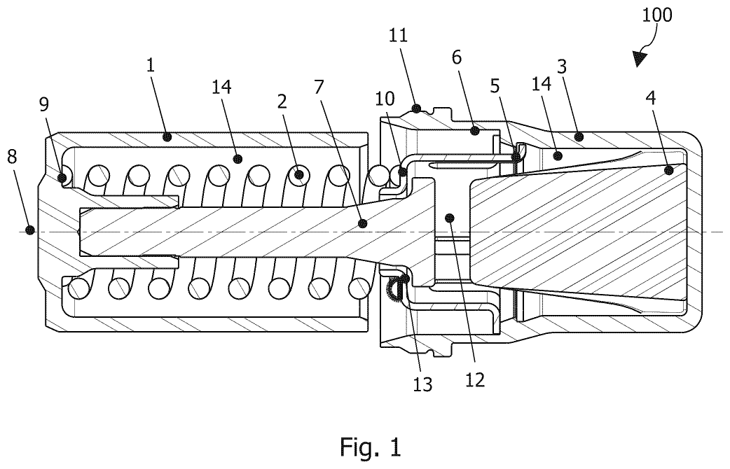

The pedal travel simulator 100 according to the invention illustrated in FIG. 1 has a simulator piston 1 that is arranged so as to be movable along the central longitudinal axis 8. An elastic element 2 is in direct contact with the simulator piston 1, said elastic element being connected by way of a first axial end 9 to the simulator piston 1 and by way of a second axial end 10 to a simulator cap 3. The elastic element 2 is however not supported directly on the simulator cap 3 but is arranged on a support sleeve 5, which in turn is fastened to the simulator cap 3.

The elastic element 2 is a sleeve-shaped spiral spring, which is arranged under preload in the pedal travel simulator 100. Owing to the preload, the elastic element 2 maintains its position within the simulator piston 1 and does not deform under its own weight. Owing to the preload, the elastic element can be positioned stably relative to other components of the simulator and makes contact with other components only at the axial ends at which this is intended. This prevents the occurrence of disturbing noises during the compression of the elastic element.

Arranged along the central longitudinal axis 8 is a force-transmitting element 7 which, after passing through an air gap 12, presses against a damping element 4. The damping element 4 is arranged in the simulator cap 3, wherein the simulator cap 3 additionally has a receiving bore 6 for the simulator piston 1.

In order that the preload of the elastic element 2 does not cause the force-transmitting element 7 to be pulled out of the arrangement in the direction of the simulator piston, a rear-side stop surface 13 is provided. A simulator force-travel curve can be adjusted by way of the length and geometrical dimensions of the force-transmitting element 7.

The region in which the elastic element 2 and the damping element 4 move and which is spanned by the simulator piston 1 and the simulator cap 3 is referred to as working space 14. This working space 14 is filled with a gas, preferably with air. Furthermore, in an installed state, the pedal travel simulator 100 is fluid-tightly closed off with respect to the surroundings. Therefore, the gas situated in the pedal travel simulator 100 cannot escape, and brake fluid cannot enter from the outside. The seal prevents foreign particles from being able to enter the pedal travel simulator 100 and generate noise emissions. For the purposes of fastening the pedal travel simulator 100, said pedal travel simulator has a fastening projection.

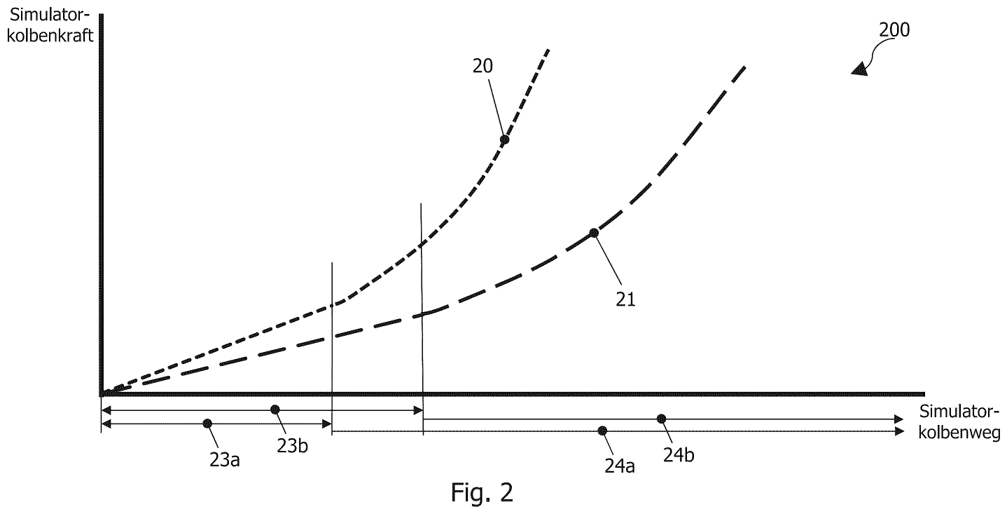

FIG. 2 shows a simulator force-travel curve 200 of a pedal travel simulator 100 according to FIG. 1. When the brake system is in a rest position, the simulator piston travel is zero, and the simulator piston force is zero. If fluid is compressed and conducted to the pedal travel simulator 100 by a piston of the master brake cylinder, the simulator piston 2 moves, and the simulator piston travel increases. If only the elastic element 2 is compressed, the pedal travel simulator 100 is situated in the first portion 23a, 23b. The simulator force at the simulator piston 1 increases to varying degrees depending on the characteristic of the elastic element 2. If a hard spring is installed, this yields a hard spring characteristic 20, and in the case of a soft spring, a soft spring characteristic 21 is obtained.

The first portion of the pedal travel simulator 100 is characterized by the fact that the simulation force increases substantially linearly. In particular, in this travel range, the gradient corresponds to the profile of exclusively the first elastic element. Through the selection of different spring characteristics, the first portion 23a can be lengthened, as shown in the alternative first portion 23b.

The transition between the first portion 23a, 23b and second portion 24a, 24b can be set in particular by way of the air gap 12 of the force-transmitting element 7. If the air gap 12 is enlarged, the second portion 24a, 24b begins later, and if the simulator cap 3 is made deeper, the air gap 12 is also enlarged. The second portion 24a, 24b is characterized by the fact that not only the elastic element 2 but also the damping element 4 is subjected to a force by the simulator piston 1.

In a first portion of the simulator force-travel curve 200, the elastic element 2 is compressed, and its first axial end 9 moves conjointly with the simulator piston 1. In the first portion, the air gap 12 is greater than zero, and the force-transmitting element does not make contact with the damping element 4.

If the simulator piston 1 is moved beyond the first portion of the simulator force-travel curve 200, said simulator piston moves into a receiving bore 6 in the simulator cap 3. In the second portion 24a, 24b, the elastic element 2 and the damping element 4 operate in parallel by virtue of the simulator piston 1 pressing against the damping element 4 via the force-transmitting element 7.

Owing to this interaction of elastic element 2 and damping element 4, the simulator force increases no longer linearly but exponentially in relation to the simulator piston. With increasing simulator piston travel, the simulator piston force imparted by the elastic element 2 and by the damping element 4 increases sharply. An authentic brake feel is thus generated at the brake pedal for the motor vehicle driver. If the simulator piston 1 reaches an axial stop in the receiving bore 6 within the simulator cap 3, the simulator piston travel can increase no further, and the simulator piston force increases abruptly (not illustrated in the curve).

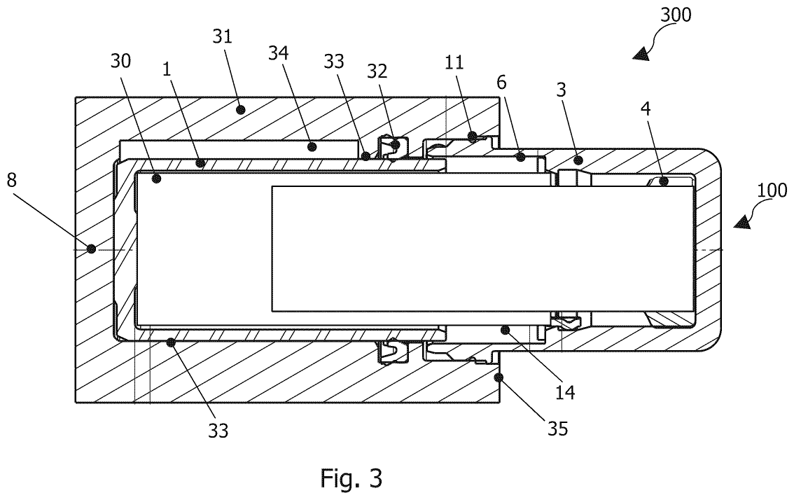

FIG. 3 shows a detail of a hydraulic block 300 having an installed a pedal travel simulator 100 according to FIG. 1. For a simplified illustration, the mechanical components of the pedal travel simulator 100 have been concealed by a redacted area 30. Identical features are denoted by the same reference signs as before. In this respect, in order to avoid repetition, reference is made to the description above.

The pedal travel simulator 100 is installed in a hydraulic block 31, said pedal travel simulator being screwed or pressed into the hydraulic block 31 by way of the fastening projection 11. The hydraulic block 31 has a cylinder bore 33 in which the simulator piston 1 is arranged so as to be movable along the central longitudinal axis 8. Here, the receiving bore 6 of the pedal travel simulator 100 is aligned with the cylinder bore 33 of the hydraulic block 31. The hydraulic block 31 furthermore has a seal 32 that ensures fluidic separation between the working space 14 and a fluid inlet 34.

The entire pedal travel simulator 100 may be assembled in a preceding production step and subsequently inserted as a structural unit into the hydraulic block. Owing to the projection of the force-transmitting element 7, which projection engages into the support sleeve 5, the simulator piston cannot fall out of the pedal travel similar 100 and is installed as an entire structural unit.

In FIG. 3, the simulator piston 1 is situated in a rest position, and no fluid pressure is applied at the fluid inlet 34. In this position, the simulator piston 1 is situated primarily in the cylinder bore 33, and only to a small extent in the receiving bore 6 of the simulator cap 3. At the transition from the first portion 23a, 23b to the second portion 24a, 24b of the simulator force-travel curve 200, the simulator piston 1 moves in the direction of the simulator cap. In this second portion 24a, 24b, a part of the simulator piston 1 may protrude beyond a delimiting surface 35 of the hydraulic block 31. The delimiting surface 35 may for example describe a surface that delimits the hydraulic block 31 with respect to the surroundings.

The hydraulic block is normally manufactured from a cuboidal metallic material, and the delimiting surface may be one of the cuboid surfaces. Alternatively, the hydraulic block 31 may have a cutout into which the pedal travel simulator 100 is inserted. The simulator 3 protrudes beyond the delimiting surface 35 and is apparent in the general visual impression of the detail of the hydraulic block 300.

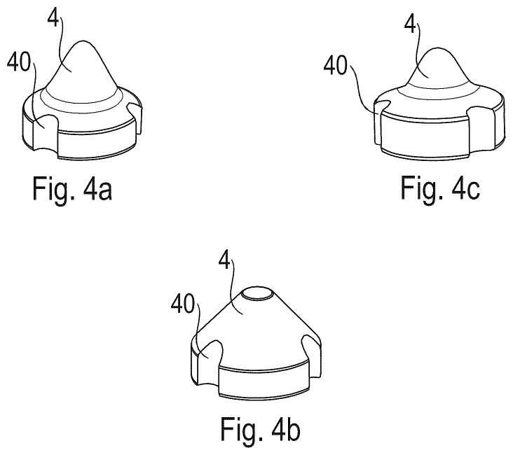

FIGS. 4a to 4c show different embodiments of damping elements 4 that can be used in a pedal travel simulator 100. The geometrical dimensions of the damping element 4 have a decisive influence on the profile of the simulator force-travel curve 200 in the second portion 24a, 24b.

The damping element 4 shown in FIG. 4a has a tip, which has the effect that only a small damping action is generated at the start of the second portion 24a, 24b of the simulator force-travel curve 200. A damping characteristic of the damping element 4 subsequently increases sharply, because the base region of the damping element 4 is very thick. The damping element can be positioned and fastened within the simulator cap 3 by means of positioning recesses 40.

The damping elements 4 shown in FIGS. 4b and 4c do not have a pronounced tip, and therefore have a damping action that imparts a high damping force already in the presence of a small piston travel.

If necessary, isolated features may also be picked out from the combinations of features disclosed here and used, with the elimination of any structural and/or functional relationship that exists between the features, in combination with other features for the purposes of delimiting the claimed subject matter. The sequence and/or number of steps of the methods may be varied.

### REFERENCE SIGNS

1 Simulator piston
2 Elastic element
3 Simulator cap
4 Damping element
5 Support sleeve
6 Receiving bore
7 Force-transmitting element
8 Central longitudinal axis
9 First axial end
10 Second axial end
11 Fastening projection
12 Air gap
13 Stop surface
14 Working space
20 Hard spring characteristic
21 Soft spring characteristic
23a First portion
23b Alternative first portion
24a Second portion
24b Alternative second portion
30 Redacted area
31 Hydraulic block
32 Seal
33 Cylinder bore
34 Fluid inlet
35 Delimiting surface
40 Positioning recess
100 Pedal travel simulator
200 Simulator force-travel curve
300 Hydraulic block

1. Pedal travel simulator (100) for a motor vehicle brake, comprising a simulator piston (1) that is received in a simulator cylinder bore so as to be movable along a central longitudinal axis (8), an elastic element (2) that makes direct contact with the simulator piston (1), and a damping element (4), wherein, in a first portion (23a, 23b) of a simulator force-travel curve (200), a simulator piston force is provided by the elastic element (2), wherein,
in a second portion (24a, 24b) of the simulator force-travel curve (200), the simulator piston force is provided by the elastic element (2) and the damping element (4) in parallel.

2. Pedal travel simulator for a motor vehicle brake according to claim 1, wherein the elastic element (2) is arranged along the central longitudinal axis (8) and has two axial ends (9, 10), wherein the elastic element (2) is supported in particular at the axial ends (9, 10).

3. Pedal travel simulator (100) for a motor vehicle brake according to claim 1, wherein the elastic element (2) is installed under axial preload.

4. Pedal travel simulator (100) for a motor vehicle brake according to claim 1, wherein the elastic element (2) has a linear force-travel characteristic.

5. Pedal travel simulator (100) for a motor vehicle brake according to claim 1, comprising a simulator cap (3) by which the pedal travel simulator (100) is shielded with respect to an installation space, wherein the damping element (4) is arranged entirely in the simulator cap (3).

6. Pedal travel simulator (100) for a motor vehicle brake according to claim 1, wherein one end (9, 10) of the elastic element (2) is supported positionally fixedly relative to the damping element (4).

7. Pedal travel simulator (100) for a motor vehicle brake according to claim 1, wherein the elastic element (2) is supported by way of a first end (9) on the simulator piston (1) and the elastic element (2) is supported by way of a second end (10) on the simulator cap (3).

8. Pedal travel simulator (100) for a motor vehicle brake according to claim 1, wherein a support sleeve (5) is provided between the simulator cap (3) and one end (9, 10) of the elastic element (2), wherein the elastic element (2) is supported via the support sleeve (5) on the simulator cap (3), and the support sleeve (5) is arranged in the simulator cap (3).

9. Pedal travel simulator (100) for a motor vehicle brake according to claim 1, wherein, in an operational state, a fluid pressure is applied to the simulator piston (1).

10. Pedal travel simulator (100) for a motor vehicle brake according to claim 1, wherein the damping element (4) has a larger hysteresis loop than the elastic element (2).

11. Pedal travel simulator (100) for a motor vehicle brake according to claim 1, wherein the elastic element (2) and the damping element (4) are arranged in a working space (14), wherein the working space (14) extends at least partially into the simulator cap (3), and the working space (14) is filled with a gas.

12. Pedal travel simulator (100) for a motor vehicle brake according to claim 1, wherein the simulator cap (3) has a receiving bore (6) in which the simulator piston (1) is received when it moves along the second portion (24a, 24b) of the simulator force-travel curve (200) during operation.

13. Pedal travel simulator (100) for a motor vehicle brake according to claim 1, wherein a force-transmitting element (7) is rigidly coupled to the simulator piston (1), wherein the force-transmitting element (7) presses against the damping element (4) after the first portion (23a, 23b) of the simulator force-travel curve (200) has been passed through.

14. Pedal travel simulator (100) for a motor vehicle brake according to claim 13, wherein the force-transmitting element (7) has a greater extent along a movement direction of the simulator piston (1) than transversely with respect to the movement direction, wherein the ratio is at least five to one, and in that a hollow cylinder is formed between the force-transmitting element (7) and a side wall of the simulator piston (1), in which hollow cylinder the elastic element (2) is arranged.

15. Pedal travel simulator (100) for a motor vehicle brake according to claim 1, wherein a volume occupied by the elastic element (2) and the volume occupied by the damping element (4) are disjoint volumes both in a rest state and in an operational state.

16. Hydraulic block (300) for a brake system of a motor vehicle, comprising a pedal travel simulator (100) according to claim 1 and comprising a plurality of bores for receiving electromagnetic valves.

17. Hydraulic block (300) according to claim 16, wherein the force-transmitting element is movable within the hydraulic block in the first portion (23a, 23b) of the simulator force-travel curve (200) and is movable at least partially out of the hydraulic block in the second portion (24a, 24b) of the simulator force-travel curve (200).

18. Hydraulic block (300) according to claim 16, wherein the hydraulic block has a master brake cylinder bore for a master brake cylinder, wherein the simulator cylinder bore is arranged orthogonally with respect to the master brake cylinder bore.

19. Hydraulic block (300) according to claim 16, wherein a fluid port of the pedal travel simulator (100) is switchably connected to a pressure chamber of the master brake cylinder.
